(19) United States
(12) Patent Application Publication
(10) Pub. No.: US 2023/0309555 A1
(43) Pub. Date: Oct. 5, 2023

(54) ENVIRONMENTALLY RESPONSIVE TRANS-2-HEXENAL SUSTAINED-RELEASE AGENT, PREPARATION METHOD, AND APPLICATION

(71) Applicant: ZHEJIANG UNIVERSITY, ZHEJIANG (CN)

(72) Inventors: Zisheng LUO, ZHEJIANG (CN); Yanqun XU, ZHEJIANG (CN); Rouwang JIANG, ZHEJIANG (CN); Dong LI, ZHEJIANG (CN); Li LI, ZHEJIANG (CN)

(73) Assignee: ZHEJIANG UNIVERSITY, ZHEJIANG (CN)

(21) Appl. No.: 17/857,149

(22) Filed: Jul. 4, 2022

(30) Foreign Application Priority Data
Mar. 14, 2022 (CN) 202210244156.9

(51) Int. Cl. A01N 31/02; A01P 3/00

(52) U.S. Cl. CPC A01N 31/02; A01P 3/00

(57) ABSTRACT

The invention provides an environmentally responsivetrans-2-hexenal sustained-release agent, a preparation method, and an application, which is obtained by using Michael addition reaction of trans-2-hexenal with a sulfhydryl compound. First, reductive glutathione is dissolved in a dimethyl sulfoxide solution, then trans-2-hexenalis added and stirred uniformly, and the resulted solution is subjected to vacuum freeze-drying to obtain the environmentally responsivetrans-2-hexenal sustained-release agent. The sustained-release agent overcomes the shortcomings of trans-2-hexenal which is volatile and not long-lasting and achieves the purpose of environmental response. The sustained-release agent reaches the effect of releasing more trans-2-hexenal efficiency with the increase of temperature or humidity and has a high bacterial inhibition effect. Moreover, a safe, environmental friendly, and effective technical means can be provided for the prevention and control of Botrytis cinerea in fruits. The sustained-release agent shows outstanding industrial significance and broad application prospects.

### CROSS-REFERENCE TO RELATED APPLICATION

This application claims the priority benefit of China application serial no. 202210244156.9, filed on Mar. 14, 2022. The entirety of the above-mentioned patent application is hereby incorporated by reference herein and made a part of this specification.

### BACKGROUND

### Technical Field

The invention belongs to the field of fruit and vegetable preservation technology, and relates to an environmentally responsivetrans-2-hexenal sustained-release agent, a preparation method, and an application.

### Description of Related Art

Botrytis cinerea is a typical necrotrophic fungal pathogen with broad host pathogenicity and can infect more than 200 species of horticultural crops, including grapes, tomatoes, strawberries, and other critical economic crops. According to statistics, gray mold disease caused by Botrytis cinerea causes an annual loss of more than 15 billion Yuan worldwide, and its degree of economic damage ranked second in the top ten fruit and vegetable fungal diseases. Fruit may be infected by Botrytis cinerea in the growth period, flowering period, fruiting period, transport storage period, etc. Some of the Botrytis cinerea will infect the fruit in the pre-harvest period, remain dormant during the growth of the fruit, and then start to grow during the postharvest storage and transport period, spread between the fruit through the development of mycelium and conidia. Mechanical damage caused during harvest and postharvest operations will also promote Botrytis cinerea to infect the fruit. After being infected by the Botrytis cinerea, the surface of the fruit appears water logged light brown patches, tissue rots, and its commercial value will be lost. Currently, broad-spectrum chemical fungicides are still the most common method to control Botrytis cinerea. In China, the fungicides used to control Botrytis cinerea mainly include benzimidazoles (such as carbendazim), dimethylimides (such as sumilex), carbamates (such as diethofencarb), and so on. Due to Botrytis cinerea’s genetic flexibility and high evolutionary potential, the abuse of fungicides will induce the natural resistance of Botrytis cinerea. The effectiveness of prevention and control decreases year by year while giving rise to pathogenic bacteria of superfungi. At the same time, the abuse of these chemical fungicides will pollute the environment and have food safety risks due to their long residual period. Therefore, the development of efficient and green prevention technology for preventing and controlling the infection of Botrytis cinerea of fruit is urged to be solved for decreasing the loss of quality of postharvest fruit in China.

Trans-2-hexenal, one of the major volatile substances in fresh fruits, has high bacterial inhibit ion activity and can inhibit the development of postharvest diseases effectively when applied to fruits and vegetables. In addition to damaging the integrity of the cell membrane and cell wall of pathogenic bacteria to realize the bacterial inhibition objective, the highly electrophilic nature of trans-2-hexenal allows it to consume nucleophilic molecules of pathogenic bacteria cells through the Michael addition reaction, which in turn causes the consumption of reducing agents indirectly in cells and further causes oxidative stress, thus providing the bacterial inhibition effect. Meanwhile, trans-2-hexenal has been allowed to use as a food additive, providing a safe premise for its application in fruit and vegetable preservation. Therefore, trans-2-hexenalhas the excellent potential to be a natural bacterial inhibitor with broad application potential in postharvest disease control based on its high bacterial inhibition activity.

However, the boiling point of trans-2-hexenal is only 47° C., which is very easy to evaporate in the natural environment, so it is difficult to provide long-term and stable bacterial protection on fruits and vegetables. The typical treatment methods include short-time closed fumigation treatment and cyclodextrin embedding. However, the former cannot guarantee that the fruits and vegetables will not be recontaminated in the later transportation, storage, and marketing period, and it also adds extra treatment time, which is a burden for fruits with short shelf life. Although the latter can slow down the release rate of trans-2-hexenal, it cannot precisely control its release amount, which shows its inadequacy in environmental response. In addition, the bacterial inhibit ion effect of trans-2-hexenal on fruits is closely related to its dose. If its content is too low, it will not have a significant bacterial inhibit ion effect, while too high will cause damage to fruits. Meanwhile, Botrytis cinerea is likely to grow in a high humidity environment, so a higher dose of trans-2-hexenal is needed to achieve the inhibition effect at higher humidity. In conclusion, the development of environmentally responsivetrans-2-hexenal sustained-release agents has great application value.

According to the study of the invention, as a typical active electrophilic substance, trans-2-hexenalcontains an α,β-unsaturated carbonyl group in its molecule, which can undergo Michael addition reaction with nucleophilic atom (such as sulfur, nitrogen)of the thiol group or the amino group. Based on the vigorous Michael addition reaction activity of trans-2-hexenal, trans-2-hexenal sustained-release precursor compounds can be prepared based on its Michael addition with thiol (—SH) analogues. This invention found that the obtained trans-2-hexenal and thiol (—SH) compounds possess reversibility and are humidity dependent. Thus, the prepared sustained-release precursor compounds have the property of humidity-response. Among the —SH containing compounds, glutathione has good thiol-responsiveness as a small molecule peptide widely present in organisms. Glutathione can be applied to functional food as an amino acid supplement, which has food safety.

Therefore, this invention chooses glutathione as the substance of safe and effective sulfhydryl compound to react with trans-2-hexenal to prepare environmentally responsive trans-2-hexenal. The prepared environmentally responsive trans-2-hexenal sustained-release compound has a good application in the prevention and control of Botrytis cinerea of fruits.

### SUMMARY

To solve the problems existing in the prior art, one of the objective of the invention is to provide an environmentally responsive trans-2-hexenal sustained-release agent.

The second objective of the invention is to provide a specific method for preparing an environmentally responsivetrans-2-hexenal sustained-release agent.

The third purpose of the invention is to provide a specific application of an environmentally responsivetrans-2-hexenal sustained-release agent.

The invention provides the following technical solutions to achieve the above objectives.

A method for preparing an environmentally responsivetrans-2-hexenal sustained-release agent uses a Michael addition reaction of trans-2-hexenal with a sulfhydryl compound to prepare the environmentally responsivetrans-2-hexenal sustained-release agent.

Further, the sulfhydryl compound is reductive glutathione.

Further, the preparation method comprises the following steps:
1) dissolving reductive glutathione in 0.05% dimethyl sulfoxide solution to prepare a mixed solution;
2) addingtrans-2-hexenal to the mixed solution made in the step 1) and stirring uniformly; and
3) performing vacuum freeze-drying on the product obtained from the step 2) to get the environmentally responsive trans-2-hexenal sustained-release agent.

Further, reductive glutathione needs to be completely dissolved in dimethyl sulfoxide solution in the step 1).

Further, the molar ratio of trans-2-hexenal in the step 2) to reductive glutathione in the step 1) is 1:1.

Further, the stirring temperature ranges from 20 to 30° C., and the stirring time ranges from 30 to 60 min in the step 2).

Further, the vacuum freeze-drying time ranges from 24 to 48 h, the cold trap temperature is below -60° C. and the vacuum level is below 20 Pa in the step 3).

The invention provides an environmentally responsive trans-2-hexenal sustained-release agent obtained by the above method.

The invention provides an application of the environmentally responsive trans-2-hexenal sustained-release agent in inhibition on growth of Botrytis cinerea.

The invention provides an application of the environmental responsive trans-2-hexenal sustained-release agent in prevention and control of Botrytis cinerea of fruits.

The sulfhydryl compounds in this invention are not limited to reductive glutathione, but can also be other compounds with Michael addition reactive sulfhydryl groups, such as cysteine, thioredoxin, which can also achieve the effect as same as the glutathione in this invention.

Compared with the prior art, this invention has the following beneficial effects:
1) This invention utilizes the reversible Michael addition reaction of trans-2-hexenal, a natural volatile substance in the fruit, with glutathione to achieve long-term stable bacterial inhibition efficacy, overcoming the difficulty of applying the pure product which is highly volatile;
2) The sustained-release agent provided by this invention is environmental responsive, achieving the effect of increasing the release of trans-2-hexenal with the increase of temperature or humidity, overcoming the shortcomings of existing technologies such as cyclodextrin embedding that cannot precisely control the release. In the meantime, it matches the characteristics of Botrytis cinerea which is more likely to grow under high humidity, improving the effect of inhibition perfectly;
3) This preparation method is simple, easy to operate, and achieve;
4) The trans-2-hexenal and reductive glutathione used in this invention are both allowed to use in the food which means its food safety is guaranteed; and
5) The sustained-release agent prepared by this invention has good application in the prevention and control of Botrytis cinerea of fruits represented by strawberries.

### BRIEF DESCRIPTION OF THE DRAWINGS

FIG. 1: Result diagram of quadrupole tandem high-resolution time-of-flight mass spectrometry (Q-TOF) of glutathione/trans-2-hexenal addition products, (a) extracted ion chromatogram (XIC), (b) spectrum of the corresponding substances at detection time from 4 to 5 min.

FIG. 2:FourierTransformInfrared(FTIR)spectrum of glutathione/trans-2-hexenal addition products.

FIG. 3: Result diagram of scanning electron microscopy (SEM), (a) glutathione, (b) a glutathione/trans-2-hexenal addition product.

FIG. 4: Thermogravimetric analysis (TGA)diagram of a glutathione/trans-2-hexenal addition product.

FIG. 5: Releasing curves of a sustained-release experiment of a glutathione/trans-2-hexenal addition product prepared by Example 1 (4° C.).

FIG. 6: Releasing curves of a sustained-release experiment of a glutathione/trans-2-hexenal addition product prepared by Example 2 (25° C.).

FIG. 7: Releasing curves of a sustained-release experiment of a glutathione/trans-2-hexenal addition product’ prepared by Example 3 (45° C.).

FIG. 8: Growth result diagram of Botrytis cinerea on a plate medium after 4 days culture and a device diagram of the experiment in Example 4, (a) a BLANK group, (b) a GSH group, (c) a GSH3h group, (d) an E-2-H group, (e) an E-2-H3h group, (f) a GSH-H group, (g) a GSH-H3h group, (h) a device diagram.

FIG. 9: Prevention and control of strawberry gray mold by a glutathione/trans-2-hexenal addition product prepared by Example 5, (a) incidence of fruit gray mold, (b) lesion diameter of fruit.

### DESCRIPTION OF THE EMBODIMENTS

To make the purpose, technical solutions, and advantages of this invention clearer, the following is a clear and complete description of the technical solutions of this invention in combination with diagrams and specific examples.

### Example 1

1.8 mmol of reductive glutathione was dissolved in 6 mL of 0.05% dimethyl sulfoxide solution completely, then 1.8 mmol of trans-2-hexenalwas added and stirred uniformly for 45 min at 25° C., the resulted solution was subjected to vacuum freeze-drying at cold trap temperature of -73° C. and vacuum level of 0.8 Pa for approximately 24 h.

20 mL glass vials were filled with 3 g of silica gel, 3 mL of saturated magnesium chloride solution, 3 mL of saturated potassium carbonate solution, 3 mL of saturated potassium iodide solution, 3 mL of saturated of potassium chloride solution, and 3 mL of pure water and then sealed until reaching relative humidity of 0%, 30%, 50%, 70%, 85% and 100%, respectively, and the mixed solution was balanced at 4° C. for 1 h. 0.05 g product was weighed and placed in a 2 mL glass vial, then transferred to the 20 mL glass vial and sealed for 7 d, and the release amount was measured every day.

### Example 2

1.8 mmol of reductive glutathione was dissolved in 6 mL of 0.05% dimethyl sulfoxide solution completely, then 1.8 mmol of trans-2-hexenalwas added and uniformly stirred for 45 min at 25° C., and the resulted solution was subjected to vacuumize freeze-drying at cold trap temperature of -73° C. and vacuum level of 0.8 Pa for approximately 24 h.

20 mL glass vials were filled with 3 g of silica gel, 3 mL of saturated magnesium chloride solution, 3 mL of saturated potassium carbonate solution, 3 mL of saturated potassium iodide solution, 3 mL of saturated potassium chloride solution, and 3 mL of pure water until reaching relative humidity of 0%, 30%, 50%, 70%, 85% and 100%, respectively, and the mixed solution was balanced at 25° C. for 1 h. 0.05 g product was weighed in a 2 mL glass vial, then transferred to the 20 mL glass vial and sealed for 7 d, and the release amount was measured every day.

### Example 3

1.8 mmol of reductive glutathione was dissolved in 6 mL of 0.05% dimethyl sulfoxide solution completely, then 1.8 mmol of trans-2-hexenalwas added and uniformly stirred for 45 min at 25° C., and the resulted solution was subjected to vacuum freeze-drying at cold trap temperature of -73° C. and vacuum level of 0.8 Pa for approximately 24 h.

20 mL glass vials were filled with 3 g of silica gel, 3 mL of saturated magnesium chloride solution, 3 mL of saturated potassium carbonate solution, 3 mL of saturated potassium iodide solution, 3 mL of saturated potassium chloride solution, and 3 mL of pure water until reaching relative humidity of 0%, 30%, 50%, 70%, 85%and 100%, respectively, and the mixed solution was balanced at 45° C. for 1 h. 0.05 g product was weighed in a 2 mL glass vial, then transferred to the 20 mL glass vial and sealed for 7 d, and the release amount was measured every day.

### Example 4

1.8 mmol of reductive glutathione was dissolved in 6 mL of 0.05% dimethyl sulfoxide solution completely, then 1.8 mmol of trans-2-hexenalwas added and uniformly stirred for 45 min at 25° C., and the resulted solution was subjected to vacuum freeze-drying at cold trap temperature of -73° C. and vacuum level of 0.8 Pa for approximately 24 h.

Botrytis cinerea lesion with a diameter of 5 mm was inoculated on the center of a potato dextrose agar medium plate. The experiment was performed by seven groups as follows:
a. A BLANK group: nothing was added;
b. A GSH group: 1 g reductive glutathione was added to a lid of a Petri dish and the Petri dish was sealed immediately;
c. A GSH3h group: 1 g reductive glutathione was added to a lid of a Petri dish and then the Petri dish was sealed after being left open for 3 h at room temperature;
d. A Group E-2-H: 20 µL trans-2-hexenal was added to a lid of a Petri dish and the Petri dish was sealed immediately;
e. An E-2-H3h group: 20 µL trans-2-hexenal was added to a lid of a Petri dish and the Petri dish was sealed after being left open for 3 h at room temperature;
f. A GSH-H group: 1 g glutathione/trans-2-hexenal addition product was added to a lid of a Petri dish and the Petri dish was sealed immediately; and
g. A GSH-H3h group: 1 g glutathione/trans-2-hexenal addition product was added to a lid of a Petri dish and the Petri dish was sealed after being left open for 3 h at room temperature.

After all groups were sealed completely, the groups were inverted and cultured at 25° C.The growth of Botrytis cinerea was checked regularly.

### Example 5

1.8 mmol of reductive glutathione was dissolved in 6 mL of 0.05% dimethyl sulfoxide solution completely, then 1.8 mmol of trans-2-hexenalwas added and uniformly stirred for 45 min at 25° C., and the resulted solution was subjected to vacuumize freeze-drying at cold trap temperature of -73° C. and vacuum level of 0.8 Pa for approximately 24 h.

Strawberries which were harvested at the same maturity, similar in size and without any infestation with insects or pets and damage, were selected. The strawberries were surface-sterilized by immersing in 0.5% (v/v) sodium hypochlorite for 5 min, then washed with sterile water to remove residues and dried at room temperature.

The strawberries were randomly divided into 2 groups, each group including 33 strawberries, and then packed into a certain volume of fresh-keeping boxes (11 strawberries per box). In group a, 4 µL of 5×10⁵cfu/mL of Botrytis cinerea solution was injected into the equatorial part of the strawberry. In group b, 6 g of glutathione/trans-2-hexenal addition product was spread at the bottom of the fresh-keeping boxes based on the strawberries were infected with bacteria. The experiment was conducted at room temperature and the strawberries were observed daily for decay, and the diameter of the lesions was measured daily.

### Result Determination

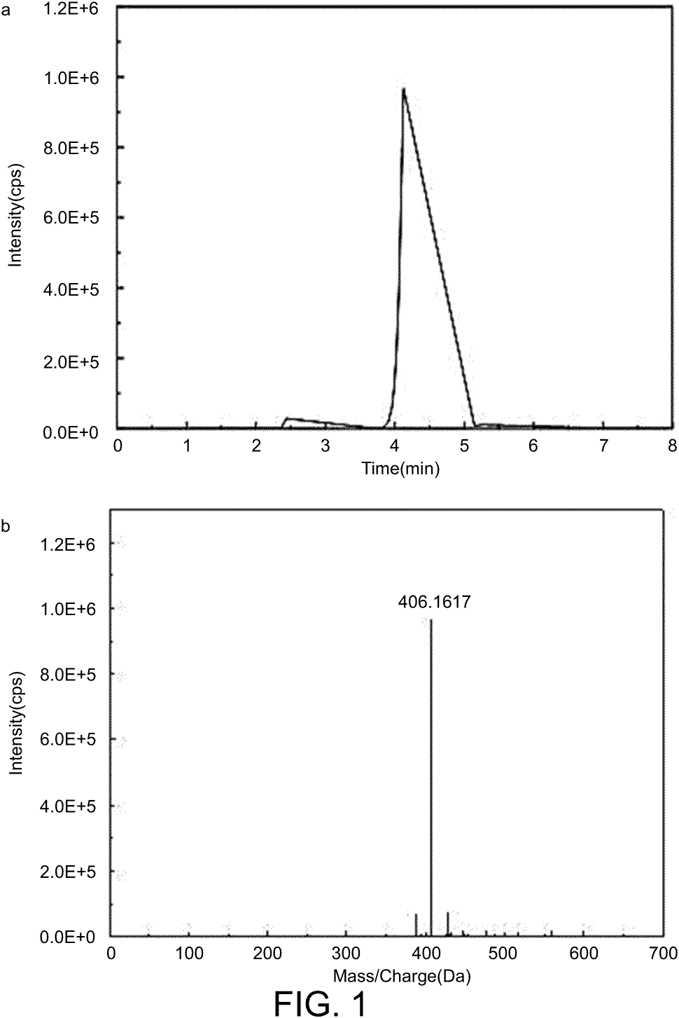

a of FIG. 1 showed an extracted ion chromatogram (XIC) obtained for looking up a substance with a chemical formula C₁₆H₂₇N₃SO₇,which was an addition product of glutathione with trans-2-hexenal. It could be seen that the substance had a strong response intensity at 4-5 min. b of FIG. 1 showed a spectrum for finding a response substance within 4-5 min of the detection time. Similarly, it could be seen that the mass-to-charge ratio had a strong response intensity at 406, which was equivalent to the relative molecular mass of C₁₆H₂₇N₃SO₇ plus one proton. In summary, it was possible to determine the formation of addition products.

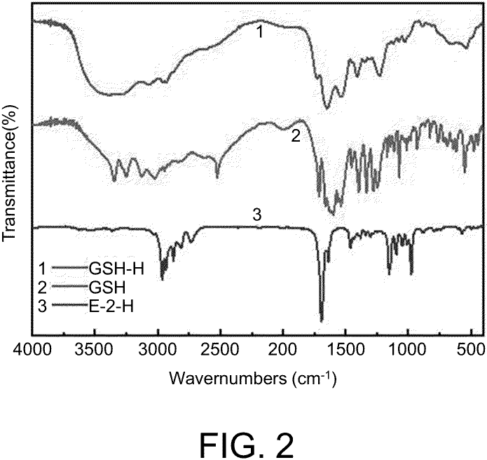

FIG. 2 showed a result diagram of FTIR spectrum. The wave number of unsaturated aliphatic aldehyde could be observed from 1,705 to 1,685 cm⁻¹, it could be seen from the experiment result that the signal of the characteristic peak of trans-2-hexenal was weakened after the addition reaction. The wave number of sulfhydryl group could be seen from 2,600 to 2,540 cm⁻¹, it could be seen that the signal of the characteristic peak of glutathione was weakened after the addition reaction. Overall, it might infer that the unsaturated aliphatic aldehyde of trans-2-hexenal and the sulfhydryl group of glutathione reacted, which further confirmed the addition reaction.

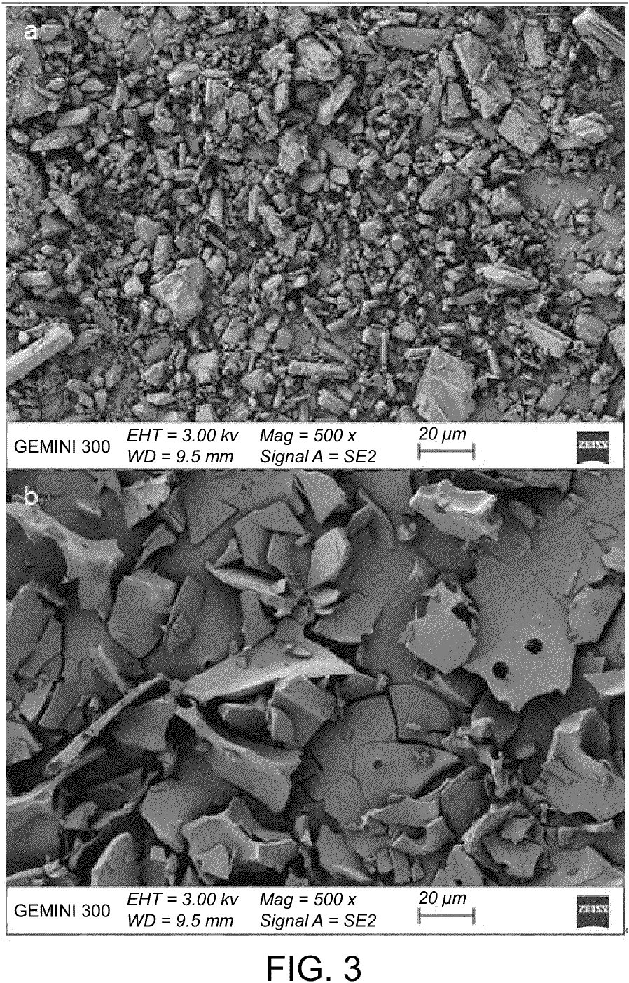

a of FIG. 3 showed an SEM of glutathione, b of FIG. 3 showedanSEM of a glutathione and glutathione/trans-2-hexenal addition product. It could be seen that glutathione appeared irregular shapes and uneven particles. In contrast, the addition product’s surface was smoother and flatter.

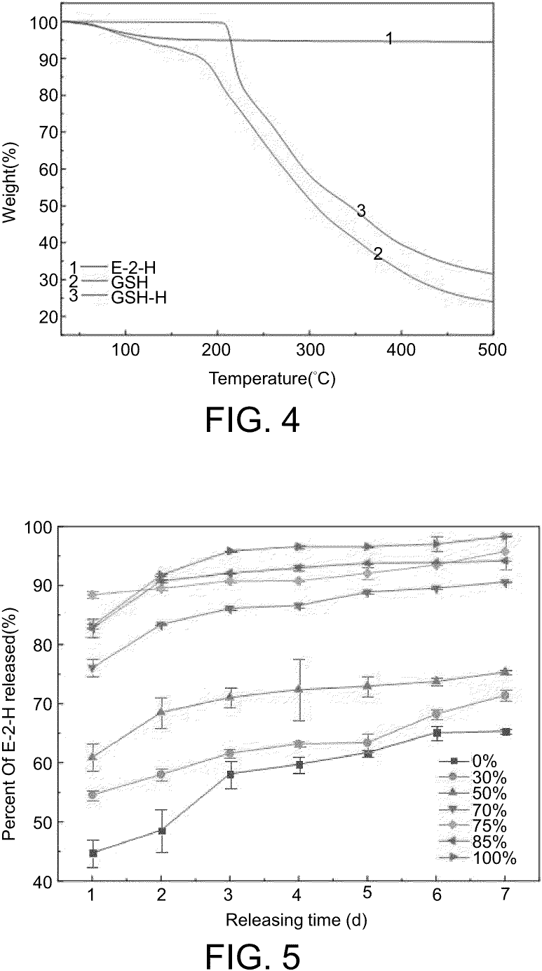

FIG. 4 showed a result diagram of TGA of the products. It could be seen that the addition reaction didn’t change the decomposition temperature of glutathione and trans-2-hexenal.

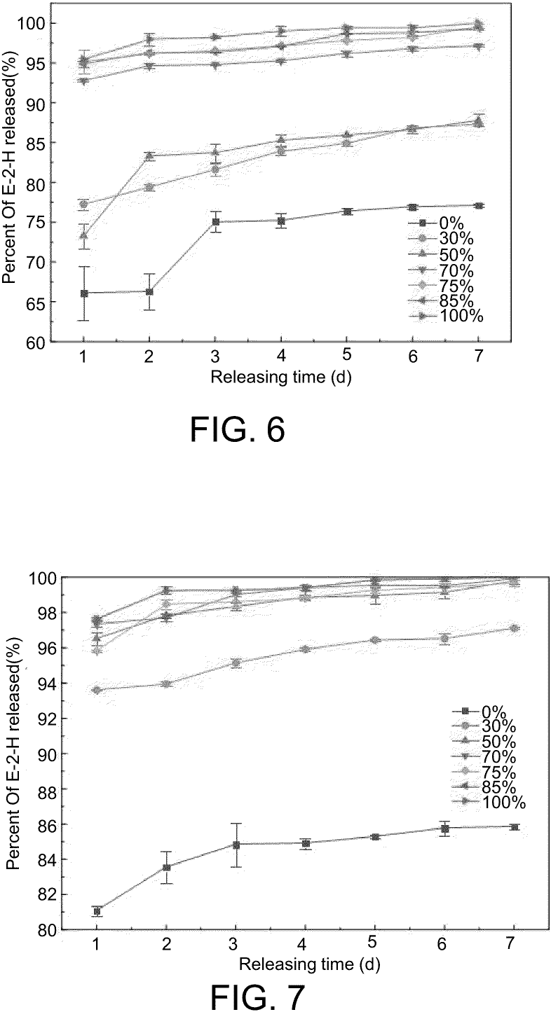

FIGS. 5-7 reflected the result of the change of the trans-2-hexenal release amount from the products with temperature and relative humidity. It could be seen that the release rate of trans-2-hexenal from the products increased with the increase in relative humidity and temperature. These results indicated that the addition product had the characteristics of environmentally responsive release of trans-2-hexenal. In addition, the release amount of trans-2-hexenal was positively correlated with the changes in temperature and humidity.

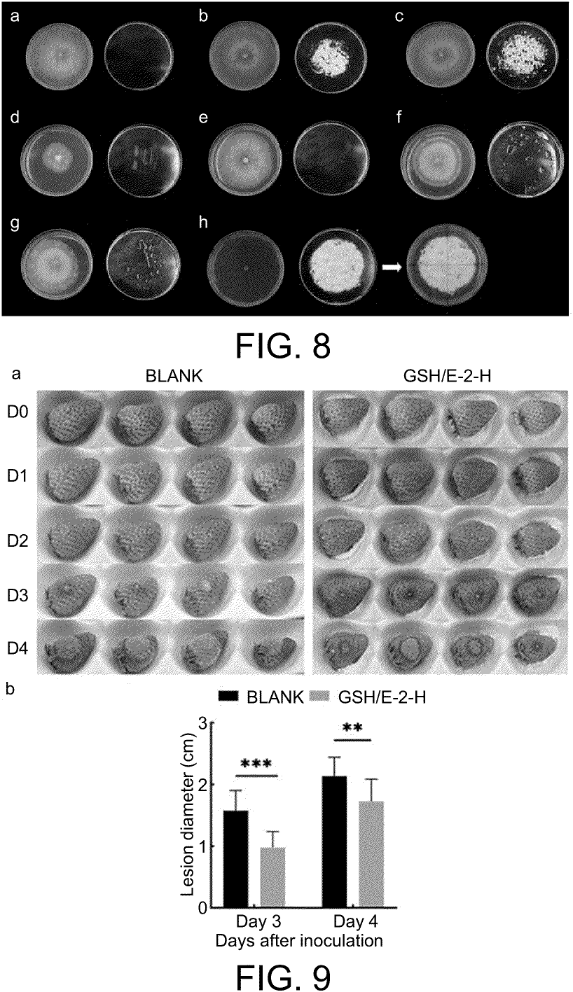

FIG. 8 showed a growth result diagram of Botrytis cinerea on a plate medium after 4 days culture (a of FIG. 8 to g of FIG. 8) and a device diagram of the experiment (h of FIG. 8). Comparing a of FIG. 8, f of FIG. 8, and g of FIG. 8, the lesion diameter of the glutathione/trans-2-hexenal addition product group was significantly smaller than that of the blank group after the same incubation time. There was little difference in the bacterial inhibition results between the group which was sealed immediately and the group which was sealed after being left open for 3 h, which led to the conclusion that the addition product was able to release trans-2-hexenal stably. Moreover, effective bacterial inhibition could be achieved even at low doses under the use of the product. Comparing a of FIG. 8, d of FIG. 8, e of FIG. 8, f of FIG. 8, and g of FIG. 8, although the group which was immediately sealed after being added withtrans-2-hexenal showed excellent bacterial inhibition effect and had a significantly lower lesion diameter than other groups, the lesion diameter of the group which was added with trans-2-hexenal and left open for 3h before sealed was larger than that of the glutathione/trans-2-hexenal addition product group. Thus, it indicated that the addition product had overcome the difficulty of the volatility of the pure product and could achieve its long-term stable bacterial inhibitory effect. Besides, comparing a of FIG. 8, b of FIG. 8, and c of FIG. 8, the growth of Botrytis cinerea in the two groups with added reductive glutathione was not significantly different from the blank group, which could help to exclude the effect of reductive glutathione on the inhibition results.

FIG. 9 showed the effectiveness of the prepared glutathione/trans-2-hexenal addition product for the prevention and control of strawberry gray mold. a of FIG. 9 showed the incidence of gray mold on fruits, and b of FIG. 9 showed the diameters of fruit lesions. Under the infection of Botrytis cinerea, strawberries appeared small yellow lesions on the second day. On the third day, the lesion turned to the appearance of outer black and inner white. And the lesion developed to be outer black and inner gray on the fourth day with the diameters expanded substantially. It could be visually seen from FIG. 9 that the experimental group was better than the control group in terms of bacterial inhibition, and the growth diameters of the lesion of the experimental group were lower than that of the control group, which indicated that the prepared glutathione/trans-2-hexenal addition product could effectively prevent and control the Botrytis cinerea of strawberry.

The above results showed that the glutathione/trans-2-hexenal addition product prepared by this invention could be synthesized successfully. It had environmentally responsive release kinetics which could adjust the release amount of trans-2-hexenal by the change of environmental temperature and humidity. In addition, the bacterial inhibition effect on fruits was longer and more effective than that of trans-2-hexenal without being subjected to addition.

In summary, the glutathione/trans-2-hexenal addition product prepared by the invention solved the problems of easy volatility and short duration of bacterial inhibition of trans-2-hexenal. It also achieved the sustained-release effect of trans-2-hexenal dynamically with the change of temperature and humidity, which had good practical applicability in fruit storage and other fields.

What is claimed is:

1. A method for preparing an environmentally responsive trans-2-hexenal sustained-release agent, using a Michael addition reaction of trans-2-hexenal with a sulfhydryl compound to prepare the environmentally responsivetrans-2-hexenal sustained-release agent.

2. The method for preparing the environmentally responsive trans-2-hexenal sustained-release agent according to claim 1, wherein the sulfhydryl compound is reductive glutathione.

3. The method for preparing the environmentally responsive trans-2-hexenal sustained-release agent according to claim 2, wherein the method comprises the steps of:
step 1) dissolving reductive glutathione in 0.05% dimethyl sulfoxide solution to prepare a mixed solution;
step 2) adding trans-2-hexenal to the mixed solution made in the step 1) and stirring uniformly to obtain a product; and
step 3) performing vacuum freeze-drying on the product obtained from the step 2) to get the environmentally responsivetrans-2-hexenal sustained-release agent.

4. The method for preparing the environmentally responsive trans-2-hexenal sustained-release agent according to claim 3, wherein reductive glutathione is completely dissolved in dimethyl sulfoxide solution in the step 1).

5. The method for preparing the environmentally responsive trans-2-hexenal sustained-release agent according to claim 3, wherein a molar ratio of trans-2-hexenal in the step 2) to reductive glutathione in the step 1) is 1:1.

6. The method for preparing the environmentally responsive trans-2-hexenal sustained-release agent according to claim 3, wherein a stirring temperature ranges from 20 to 30° C., and a stirring time ranges from 30 to 60 min in the step 2).

7. The method for preparing the environmentally responsive trans-2-hexenal sustained-release agent according to claim 3, wherein a vacuum freeze-drying time ranges from 24 to 48 h, a cold trap temperature is below -60° C., and a vacuum level is below 20 Pa in the step 3).

8. An environmentally responsive trans-2-hexenal sustained-release agent obtained by the method for preparing the environmentally responsive trans-2-hexenal sustained-release agent according to claim 1.

9. An environmentally responsive trans-2-hexenal sustained-release agent obtained by the method for preparing the environmentally responsive trans-2-hexenal sustained-release agent according to claim 2.

10. An environmentally responsive trans-2-hexenal sustained-release agent obtained by the method for preparing the environmentally responsive trans-2-hexenal sustained-release agent according to claim 3.

11. An environmentally responsive trans-2-hexenal sustained-release agent obtained by the method for preparing the environmentally responsive trans-2-hexenal sustained-release agent according to claim 4.

12. An environmentally responsive trans-2-hexenal sustained-release agent obtained by the method for preparing the environmentally responsive trans-2-hexenal sustained-release agent according to claim 5.

13. An environmentally responsive trans-2-hexenal sustained-release agent obtained by the method for preparing the environmentally responsive trans-2-hexenal sustained-release agent according to claim 6.

14. An environmentally responsive trans-2-hexenal sustained-release agent obtained by the method for preparing the environmentally responsive trans-2-hexenal sustained-release agent according to claim 7.

15. An application of the environmentally responsivetrans-2-hexenal sustained-release agent according to claim 8 in inhibition on growth of Botrytis cinerea.

16. The application according to claim 15, wherein the environmentally responsivetrans-2-hexenal sustained-release agent is applied to prevention and control of Botrytis cinerea on fruits.
